(19) United States
(12) Patent Application Publication
(10) Pub. No.: US 2026/0363178 A1
(43) Pub. Date: Nov. 19, 2026

(54) SYSTEMS AND METHOD FOR PREVENTING PHOTOBLEACHING IN PLANTS GROWN UNDER ARTIFICIAL LIGHTING

(71) Applicant: SIGNIFY HOLDING B.V., EINDHOVEN (NL)

(72) Inventors: BRIAN POEL, AUSTIN, TX (US); DAVID HAWLEY, AUSTIN, TX (US)

(21) Appl. No.: 19/480,121

(22) PCT Filed: Apr. 22, 2024
(86) PCT No.: PCT/EP2024/060862

§ 371 Date: Oct. 30, 2025

Related U.S. Application Data
(60) Provisional application No. 63/463,175, filed on May 1, 2023.

(30) Foreign Application Priority Data
Jul. 17, 2023 (EP) 23185709.5

(51) Int. Cl. A01G 7/04

(52) U.S. Cl. CPC A01G 7/045

(57) ABSTRACT

A method for providing horticultural lighting is provided. The method includes exposing a cultivar to a spectrally controllable light output generated by an LED-based light fixture. The light output includes a predetermined range of photosynthetic photon flux density and a red-light portion, within a wavelength range of 600 to 700 nm, of at least 40% of the total spectrum of the light output. The method then: (1) calculates an absolute number of red photons in the red-light portion; (2) iteratively determines a range of photobleaching thresholds for the one or more cultivar based, at least in part, on the absolute number of red photons; and (3) controls the LED-based light fixture so that the absolute number of red-light photons is below the range of photobleaching thresholds.

### FIELD OF THE INVENTION

The present disclosure is generally directed to providing horticultural lighting to one or more cultivars in a horticulture production facility. More specifically, the disclosure is directed to providing horticultural lighting in a manner that avoids photobleaching.

### BACKGROUND OF THE INVENTION

Growing crops under spectrally controllable artificial light is generally known in the art. Plant growth occurs through photosynthesis, where the plant converts energy from light into biochemical energy that the plant can use to fuel growth. Chlorophyll is the most abundant pigment in plants and is a key component in photosynthesis. Moreover, chlorophyll is particularly efficient at absorbing light in the red region of the visible light spectrum, leading to improved yield when crops are grown under artificial light with a red-light component.

However, when crops are exposed to high intensities of red light, there is a risk that the plants will absorb energy at a greater rate than they can use it. This can lead to an excess of highly reactive elements that degrade the chemical structure of the chlorophyll. When chlorophyll pigment is destroyed, the plant tissue is left with an off-white “bleached” appearance that is unappealing to consumers. Especially in the cannabis market, bleached cannabis buds are perceived to be aesthetically unappealing, have an unpleasant flavor, and be less potent. Worse still, floral buds at the top of the canopy, where photobleaching often occurs, typically have the highest potency and are highly valued by customers. Diminishing the value of these buds can significantly impact the overall value of a grower's yield.

To minimize the possibility of photobleaching in a red-rich spectrum, growers will typically limit the total light intensity in the horticulture environment. However, this strategy often leads to a decrease in overall crop yield. Accordingly, there remains a need in the art for a method and system of providing horticultural lighting in the red-rich spectrum that exposes the crops to the optimal intensity, while reducing or avoiding photobleaching.

### SUMMARY OF THE INVENTION

The present disclosure is generally directed to optimizing the horticultural lighting of a cultivar in order to maximize crop yield, while avoiding photobleaching. This is partially achieved by calculating an absolute number of red photons the cultivars are exposed to, in a manner that accounts for the botanical properties of particular cultivars. Generally, growers can avoid photobleaching by ensuring that crops are exposed to both a sufficiently low intensity of light and a sufficiently low percentage of red light in the overall spectrum of horticultural lighting. However, the systems and methods disclosed herein improve upon conventional approaches partially through the realization that the absolute value of red photons that the crops are exposed to is a better predictor of photobleaching than either light intensity or red-light percentage. Broadly, the system, method, or device exposes a cultivar to a spectrally controllable light output comprising a red-light portion, calculates the absolute number of red photons the cultivar is being exposed to, iteratively determines a range of photobleaching thresholds for the cultivar, based at least in part, on the absolute number of red photons, and controls the light that the cultivar is exposed to so that the absolute number of red-light photons is below the range of photobleaching thresholds.

Generally, in one aspect, the disclosure relates to a method of delivering horticultural lighting. The method includes exposing a cultivar to a spectrally controllable light output generated by an LED-based light fixture. The light output has a predetermined range of photosynthetic photon flux density and a red-light portion, within a wavelength range of 600 to 700 nm, of at least 40% of the total spectrum of the light output. The method may further include i) calculating an absolute number of red photons in the red-light portion; ii) iteratively determining a range of photobleaching thresholds for the cultivar based, at least in part, on the absolute number of red photons; and iii) controlling the LED-based light fixtures so that the absolute number of red-light photons is below the range of photobleaching thresholds.

In some embodiments, the method further includes detecting a photobleaching value. For example, detecting the photobleaching value could comprise a bleaching depth and/or an incidence of photobleaching.

In another aspect, the step of controlling the LED-based light fixture further comprises controlling either the photosynthetic flux density and/or the percentage of the red-light portion.

In some embodiments, the range of photobleaching thresholds is about 550 μmol·m⁻²·s⁻¹ of red photons. The photosynthetic photon flux density could be between about 800 μmol·m⁻²·s⁻¹ and 2500 μmol m⁻²·s⁻¹ and the red-light percentage could be below 80%.

In another aspect the range of photobleaching thresholds is determined for different periods of the cultivar's life cycle.

A further aspect of the disclosure relates to a system for delivering horticultural lighting. The system includes an LED-based light fixture, wherein the LED-based light fixture is configured to generate a light output illuminating a cultivar, and wherein the light output comprises a predetermined range of photosynthetic photon flux density and a red-light portion, within a wavelength range of 600 to 700 nm, of at least 40% of the total spectrum of the light output. The system further includes a controller coupled to the LED-based light fixture, wherein the controller is configured to i) determine the predetermined range of photosynthetic photon flux density and the red-light portion by spectrally controlling the LED-based light fixture; ii) calculate an absolute number of red photons in the red-light portion; iii) iteratively determine a range of photobleaching thresholds for the cultivar, based at least in part on, the absolute number of red photons; and iv) control the LED-based light fixture so that the absolute number of red photons is below the range of photobleaching thresholds.

In some embodiments, the system further includes a sensor configured to detect a photobleaching value. For example, detecting the photobleaching value could further comprise determining a bleaching depth and/or an incidence of photobleaching. The LED-based light fixture may control the photosynthetic flux density and/or the percentage of the red-light portion.

In some embodiments, the range of photobleaching thresholds is about 550 μmol·m⁻²·s⁻¹ of red photons. The photosynthetic photon flux density could be between about 800 μmol·m⁻²·s⁻¹ and 2500 μmol m⁻²·s⁻¹ and the red-light percentage could be below 80%. The range of photobleaching thresholds may be determined for different periods of the cultivar's life cycle.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs. It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

The term “light source” should be understood to refer to any one or more of a variety of radiation sources, including, but not limited to, LED-based sources (including one or more LEDs as defined above). A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components.

The term “spectrum” should be understood to refer to any one or more frequencies (or wavelengths) of radiation produced by one or more light sources. A given spectrum may have a relatively narrow bandwidth (e.g., a FWHM having essentially few frequency or wavelength components) or a relatively wide bandwidth (several frequency or wavelength components having various relative strengths). It should also be appreciated that a given spectrum may be the result of a mixing of two or more other spectra (e.g., mixing radiation respectively emitted from multiple light sources). For purposes of this disclosure, the term “color” is used interchangeably with the term “spectrum.” However, the term “color” generally is used to refer primarily to a property of radiation that is perceivable by an observer (although this usage is not intended to limit the scope of this term). Accordingly, the terms “different colors” implicitly refer to multiple spectra having different wavelength components and/or bandwidths. It also should be appreciated that the term “color” may be used in connection with both white and non-white light.

In various implementations, a processor or controller can be associated with one or more storage media (generically referred to herein as “memory,” e.g., volatile and non-volatile computer memory such as ROM, RAM, PROM, EPROM, and EEPROM, floppy disks, compact disks, optical disks, magnetic tape, Flash, OTP-ROM, SSD, HDD, etc.). In some implementations, the storage media can be encoded with one or more programs that, when executed on one or more processors and/or controllers, perform at least some of the functions discussed herein. Various storage media can be fixed within a processor or controller or can be transportable, such that the one or more programs stored thereon can be loaded into a processor or controller so as to implement various aspects as discussed herein. The terms “program” or “computer program” are used herein in a generic sense to refer to any type of computer code (e.g., software, firmware, or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is an illustration of photobleaching in a cultivar grown under artificial red-light.

FIG. 2 is an illustration of a system for providing horticultural lighting to a cultivar according to some aspects of the present disclosure.

FIG. 3 is a flowchart of a method for providing horticultural lighting according to some aspects of the present disclosure.

FIG. 4 is an illustration of a cultivar at different stages of its lifecycle.

### DETAILED DESCRIPTION

The present disclosure is generally directed to optimizing the horticultural lighting of a cultivar grown under an artificial light with a red-light component in order to maximize crop yield, while avoiding photobleaching. This is partially achieved by calculating an absolute number of red photons the cultivars are exposed to, in a manner that accounts for the botanical properties of particular cultivars. Broadly, the system, method, or device exposes a cultivar to a spectrally controllable light output comprising a red-light portion, calculates the absolute number of red photons the cultivar is exposed to, iteratively determines a range of photobleaching thresholds for the cultivar, based at least in part, on the absolute number of red photons, and controls the light that the cultivar is exposed to so that the absolute number of red-light photons is below the range of photobleaching thresholds.

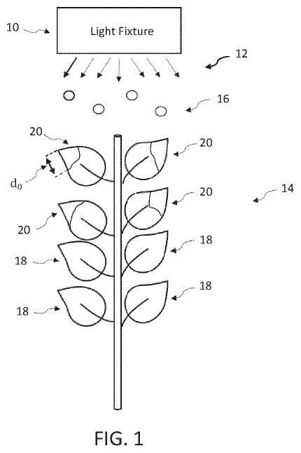

FIG. 1 is an illustration of growing in a cultivar under an artificial light in a horticultural environment. For the purposes of this disclosure, a cultivar refers broadly to any crop variety. The term “horticulture” relates to (intensive) plant cultivation for human use and is very diverse in its activities, incorporating plants for food (fruits, vegetables, mushrooms, culinary herbs) and non-food crops (flowers, trees and shrubs, turf-grass, hops, grapes, medicinal herbs). The term “crop” is used herein to indicate the horticulture plant that is grown or was grown. Plants of the same kind grown on a large scale for food, clothing, etc., may be called crops. A crop is a non-animal species or variety that is grown to be harvested as e.g. food, livestock fodder, fuel, or for any other economic purpose. The term “crop” may also relate to a plurality of crops. Horticulture crops may especially refer to food crops (tomatoes, peppers, cucumbers and lettuce), as well as to plants (potentially) bearing such crops, such as a tomato plant, a pepper plant, a cucumber plant, etc. Horticulture may herein in general relate to e.g. crop and non-crop plants. Examples of crop plants are Rice, Wheat, Barley, Oats, Chickpea, Pea, Cowpea, Lentil, Green gram, Black gram, Soybean, Common bean, Moth bean, Linseed, Sesame, Khesari, Sunhemp, Chillies, Brinjal, Tomato, cucumber, Okra, Peanut, Potato, Corn, Pearlmillet, Rye, Alfalfa, Radish, Cabbage, lettuce, pepper, Sunflower, Sugarbeet, Castor, Red clover, White clover, Safflower, Spinach, Onion, Garlic, Turnip, Squash, Muskmelon, Watermelon, Cucumber, Pumpkin, Kenaf, Oilpalm, Carrot, Coconut, Papaya, Sugarcane, Coffee, Cocoa, Tea, Apple, Pears, Peaches, Cherries, grapes, Almond, Strawberries, Pine apple, Banana, Cashew, Irish, Cassava, Taro, Rubber, Sorghum, Cotton, Triticale, Pigeonpea, and Tobacco. Especially of interest are cannabis crops.

In FIG. 1 a cultivar 14 is grown under a light fixture 10. In various embodiments, the light fixtures 10 are spectrally controllable LED-based light fixtures. For example, the light fixture 10 of FIG. 1 may include red LEDs, blue LEDs, green LEDs, and far-red LEDs. However, the systems and methods of this disclosure are not limited to such an LED arrangement, and real-world systems will likely include many more light sources.

The light fixture 10 exposes the cultivar 14 to a light output 12. This light output 12 is configured to be spectrally controllable such that the cultivar 14 is exposed to a predetermined range of photosynthetic photon flux density. The photosynthetic photon flux density (“PPFD”) can, for example, be measured in units of μmol·m^{·2}·s⁻¹ and quantifies the incidence of photons per unit time on a unit surface area of the cultivar. The light output 12 is further configured to have a spectrally controllable red-light portion. The red-light portion can, for example, be generated by red-light LEDs at a wavelength of 600 to 700 nanometers. The red-light portion can, for example, be quantified as a percentage of the total light output 12. In one example, the red-light portion can be between 40 to 80 percent of the total light output.

The red-light portion of the light output 12 comprises red photons 16. The red photons 16 deliver energy to cultivar 14 which the cultivar 14 then converts to biochemical energy through photosynthesis. The cultivar 14 absorbs the energy from the red photons at chlorophyll-rich regions 18. Chlorophyll is particularly efficient at absorbing red photons 16. Accordingly, exposing chlorophyll-rich regions 18 to red photons 16 tends to increase the biochemical energy available to cultivar 14 for driving metabolic processes, such as growth.

The cultivar 14 uses the energy absorbed from red photons 16 to split water into hydrogen and oxygen, extracting electrons in the process. Normally, proteins carry away the extracted electrons to fuel downstream processes. However, when cultivar 14 is exposed to a light output 20 containing either a high photosynthetic photon flux density or red-light portion, these electrons accumulate faster than the proteins can move them. The continued incoming energy from the red photons 16, combined with the proliferation of electrons creates a highly reactive chemical environment in the chlorophyll-rich regions 18. This high reactivity can lead to degradation of the chemical structure of chlorophyll and the discoloration that is characteristic of photobleaching 20.

FIG. 1 shows cultivar 14 where some of the chlorophyll-rich regions 18 have experienced photobleaching 20. There are several techniques for determining a photobleaching value of a cultivar. For example, a photobleaching value can quantify the number of instances of photobleaching experienced by a given cultivar. The cultivar 14 of FIG. 1 illustrates four instances of photobleaching 20. In another example, a photobleaching value can be based on the severity of individual instances of photobleaching 20. For example, the photobleaching value can be based on a photobleaching depth do, that measures how far the photobleached area extends. Alternatively, a photobleaching value can be some other metric that combines these techniques or other techniques.

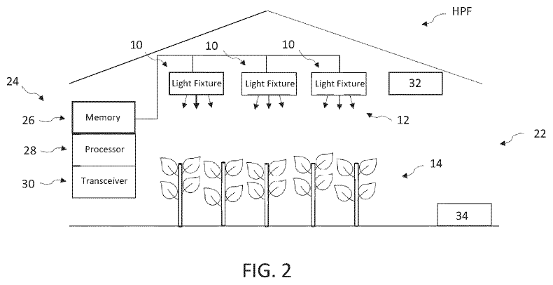

FIG. 2 is an illustration of a system 22 for delivering horticultural lighting according to some aspects of the present disclosure. The system 22, for example, is implemented in a horticulture production facility (“HPF”). The HPF may be any variety of enclosed or partially enclosed cultivation environment, such as a greenhouse, plant factory, indoor vertical farm, etc. In some instances, the system 22 includes light fixtures 10 within the HPF. The light fixtures 10 may use LEDs to expose cultivars 14 to a light output 12.

In FIG. 2 the light fixtures 10 are shown hanging from the top of the HPF 22. However, this not meant to be limiting and the light fixtures are contemplated to take the form of any arrangement including a freestanding light source, a grid of LEDs, or other lighting geometries.

The system 22 may include a controller 24. In some embodiments, the controller 24 is connected to lighting fixture 10. The controller 24 may include a memory 26, processor 28, and transceiver 30. The controller 24 may be connected to lighting fixture 10 through a wired or wireless connection. For example, transceiver 28 of the controller 24 may be used to implement a wireless connection via any applicable protocol, such as Bluetooth, Wi-Fi, Zigbee, ultrawideband, etc. In some examples, the controller 24 may be arranged within the HPF 22, such as within a control panel. In other examples, the controller 24 may be outside of the HPF 22, such as within an external office, control room, wiring closet, equipment room, or server room.

In some embodiments, the system 22 includes a sensor 32. The sensor 32 may be used to detect a photobleaching threshold. For example, the sensor 32 can take the form of a red-green-blue (RGB) camera, a thermal camera, or an infrared (IR) camera. The sensor 32 can transmit images of the light output 12, the cultivar 14, or both to the controller 24. The controller 24 can then analyze the images from sensor 32 to determine a photobleaching value for a given cultivar 14. For example, the controller can assess the images for dimensions and color to detect regions experiencing photobleaching 20 and then output an incidence of photobleaching or a photobleaching depth.

In some examples, the system 22 can include an environmental sensor 34. Beyond the light output 12, other environmental factors can impact whether photobleaching 20 occurs. For example, growing the cultivars 14 in a higher temperature environment may lead to a greater amount of excess energy in the chlorophyll-rich regions 18, and a correspondingly greater chance of photobleaching. Environmental sensor 34 can take the form of a temperature or humidity sensor to allow the system to monitor various environmental factors.

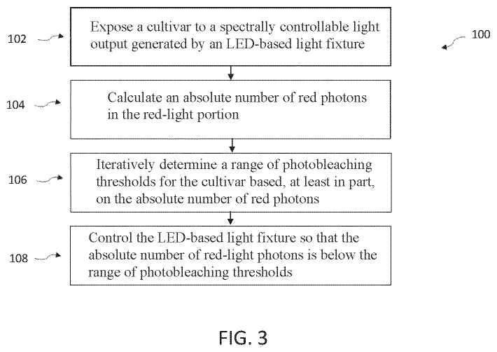

FIG. 3 is flowchart illustrating a method 100 for providing horticultural lighting according to some aspects of the present disclosure. At step 102, the method 100 exposes a cultivar to a spectrally controllable light output generated by an LED-based light fixture, the light output comprising a predetermined range of photosynthetic photon flux density and a red-light portion, within a wavelength range of 600 to 700 nm, of at least 40% of the total spectrum of the light output. This step can be performed, for example, by any of the light fixtures previously described. In some embodiments, the controller automatically determines the predetermined range of photosynthetic photon flux density and the red-light portion by spectrally controlling the LED-based light fixture. In some examples, a user can input a desired photosynthetic photon flux density and red-light portion. In some examples the controller is wirelessly connected to a tablet, phone, or computer where the user can input the predetermined range of photosynthetic photon flux density and red-light portion.

At step 104, the method calculates an absolute number of red photons in the red-light portion. Equation 1 below provides an example of how the absolute number of red photons can be calculated where PPFD is the photosynthetic photon flux density and the red-light portion is determined as a percentage of the total light output.

(Absolute Number of Red Photons)=(PPFD)(Red-Light Portion %) (1)

The photosynthetic photon flux density quantifies the incidence of photons per unit time on a unit surface area of the cultivar and the red-light portion quantifies the percentage of the total light output that is red-light. Therefore, multiplying them together provides a value for the number of incident red-light photons per unit time on a unit surface of the cultivar.

At step 106, the method 100 iteratively determines a range of photobleaching thresholds for the one or more cultivar based, at least in part, on the absolute number of red photons. For example, if the cultivar exhibits photobleaching under the current predetermined range of photosynthetic photon flux density and red-light portion, the method could expose the cultivar to a decreased PPFD, red-light percentage, or both. If the cultivar still exhibits signs of photobleaching, then the method will be repeated with another decrease in either PPFD, red-light percentage, or both.

On the other hand, if the cultivars do not exhibit photobleaching under the initial lighting regime, the method can be repeated with an increase in PPFD, red-light percentage, or both. This method can be repeated until an optimal lighting regime is reached. For example, many cannabis cultivars will not experience photobleaching when exposed to a light output comprising about 550 μmol m⁻²·s⁻¹ of red photons. This corresponds to a photosynthetic photon flux density of between about 800 μmol·m⁻²·s⁻¹ to 2500 μmol·m⁻²·s⁻¹ and a red-light portion of about 40 to 80 percent. Basing the photobleaching threshold, at least in part, on the absolute number of red photons allows the PPFD and red-light portion to be manipulated as design variables. For example, exposing the cultivar to a light output with a PPFD of 687.5 μmol·m⁻²·s⁻¹ that is 80 percent red-light or a PPFD of 1100 μmol·m⁻²·s⁻¹ that is 50 percent red-light will both lead to an absolute number of red photons of 550 μmol·m⁻²·s⁻¹.

The number of iterations performed in step 106 can be modified according to the specific application. For example, it is likely that fewer iterations would be required for a crop that is less prone to photobleaching or for which more information is known beforehand about its optical properties. In some embodiments, the method 100 could include determining a photobleaching value using information detected by a sensor 32. For example, the method 100 could include using the photobleaching value to decide if more iterations are required to determine the photobleaching threshold.

In step 108, the method 100 controls the light fixture so that the absolute number of red-light photons is below the range of photobleaching thresholds. This can include, for example setting the predetermined range of photosynthetic photon flux density, red-light portion, or both so that the absolute number of red photons, as calculated in Equation 1 stays below the range of photobleaching thresholds. Step 108 could include continuously monitoring the light output and the environment that the cultivar 14 is being grown in to ensure that the absolute number of red photons stays below the threshold. For example, an increase in temperature could lead to a decreased photobleaching threshold.

The method 100 could be performed by a processor 24 like the one described elsewhere in this disclosure. However, the method 100 could also be performed in other ways. For example, by a user visually monitoring the cultivars and controlling the light output via a user interface. This interface could possibly include controls physically mounted on to light fixture, or a phone, tablet, or computer wirelessly connected to the lighting fixture.

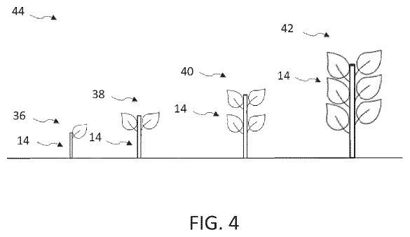

FIG. 4 illustrates a cultivar 14 at various stages of its life cycle 44. In some embodiments of the present disclosure, a photobleaching threshold range can be determined for different periods of the cultivar's 14 life cycle 44. For example, the method could comprise determining a seedling threshold range when the cultivar has reached a seedling stage 36. This can be, for some cultivars, at about two weeks. The method could control the light output to stay below the seedling threshold range until the cultivar has reached a vegetative stage 38. This could possibly occur at about four weeks, where the method would then determine a vegetative threshold range. The method could control the light output to stay below the seedling threshold range until the cultivar reaches a flowering stage 40. For some cultivars this could be at about six weeks. The method would then determine a flowering threshold. The method could control the light output to stay below the seedling threshold range until the cultivar reaches a harvesting stage 42. At this points the cultivar would be ready for harvesting and possible sale.

This example is not meant to be limiting with regards to any specific time periods or the number of different ranges of photobleaching thresholds determined. For example, different types of crops and different cultivars of the same crop will have different life cycle timelines. Accordingly, the particular system or method would vary depending on the specific application. In this manner, the system or method can not only account for variations in botanical properties of different cultivars, but also for variations in botanical properties of a particular cultivar at different periods in the cultivar's life cycle 44.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects can be implemented using hardware, software, or a combination thereof. When any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some examples, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions can also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A method of delivering horticultural lighting, the method comprising:
exposing a cultivar to a spectrally controllable light output generated by an LED-based light fixture, the light output comprising a predetermined range of photosynthetic photon flux density and a red-light portion, within a wavelength range of 600 to 700 nm, of at least 40% of the total spectrum of the light output;
calculating an absolute number of red photons in the red-light portion; iteratively determining a range of photobleaching thresholds for the cultivar based, at least in part, on the absolute number of red photons the predetermined range of photosynthetic photon flux density and the red light portion; and
controlling the LED-based light fixture so that the absolute number of red-light photons is below the range of photobleaching thresholds.

2. The method of claim 1, further comprising detecting a photobleaching value.

3. The method of claim 2, wherein detecting the photobleaching value further comprises determining a bleaching depth (do) and/or an incidence of photobleaching.

4. The method of claim 1, wherein controlling the LED-based light fixture further comprises controlling either the photosynthetic flux density and/or the percentage of the red-light portion.

5. The method of claim 1, wherein the range of photobleaching thresholds is about 550 μmol·m⁻²·s⁻¹ of red photons.

6. The method of claim 5, wherein the photosynthetic photon flux density is between about 800 μmol·m⁻²·s⁻¹ and 2500 μmol·m⁻²·s⁻¹ and wherein the red-light percentage is below 80%.

7. The method of claim 1, further comprising determining the range of photobleaching thresholds for different periods of the cultivar's life cycle.

8. A system for delivering horticultural lighting, comprising:
an LED-based light fixture, wherein the LED-based light fixture is configured to generate a light output illuminating a cultivar, wherein the light output comprises a predetermined range of photosynthetic photon flux density and a red-light portion, within a wavelength range of 600 to 700 nm, of at least 40% of the total spectrum of the light output and
a controller coupled to the LED-based light fixture, wherein the controller is configured to:
determine the predetermined range of photosynthetic photon flux density and the red-light portion by spectrally controlling the LED-based light fixture calculate an absolute number of red photons in the red-light portion;
iteratively determine a range of photobleaching thresholds for the cultivar, based at least in part on, the absolute number of red photons, the predetermined range of photosynthetic photon flux density and the red-light portion; and
control the LED-based light fixture so that the absolute number of red photons is below the range of photobleaching thresholds

9. The system of claim 8, further comprising a sensor configured to detect a photobleaching value.

10. The system of claim 9, wherein the photobleaching value is a bleaching depth (do) and/or an incidence of photobleaching.

11. The system of claim 8, wherein the LED-based light fixture controls either the photosynthetic flux density and/or the percentage of the red-light portion.

12. The system of claim 8, wherein the photobleaching threshold is about 550 μmol·m⁻²·s⁻¹ of red photons.

13. The system of claim 12, wherein the photosynthetic photon flux density is between about 800 μmol·m⁻²·s⁻¹ and 2500 μmol·m⁻²·s⁻¹ and wherein the red-light percentage is below 80%.

14. The system of claim 8, wherein the controller is further configured to determine the range of photobleaching thresholds for different periods of the cultivar's life cycle.
